(19) United States
(12) Patent Application Publication
(10) Pub. No.: US 2013/0074338 A1
(43) Pub. Date: Mar. 28, 2013

(54) PRE-COMPRESSED SEAL INCLUDING REMOVABLE PRE-COMPRESSION MEMBER

(71) Applicants: JEFFREY EUGENE SWENSEN, Eldersburg, MD (US); Micheal Sean Parker, Laurel, MD (US); Joseph IIbong Kim, Frederick, MD (US)

(72) Inventors: JEFFREY EUGENE SWENSEN, Eldersburg, MD (US); Micheal Sean Parker, Laurel, MD (US); Joseph IIbong Kim, Frederick, MD (US)

(21) Appl. No.: 13/104,585

(22) Filed: May 10, 2011

Related U.S. Application Data
(63) Continuation-in-part of application No. 12/813,118, filed on Jun. 10, 2010, now Pat. No. 8,366,113.

(51) Int. Cl. F02C 7/28; B23P 11/00; F16J 15/02

(52) U.S. Cl. 29/889.22; 277/630

(57) ABSTRACT

A seal is provided that includes a resilient, arc-shaped body having a pair of sealing portions movable between a pre-compressed state and a compressed state. A removable pre-compression member slidingly engages the seal body along at least a portion of its length to hold the sealing portions in the pre-compressed state. In an embodiment, the seal body includes a pair of first retaining features and the pre-compression member includes a retaining portion having a pair of second retaining features that engage the pair of first retaining features to hold the sealing portions in the pre-compressed state. A strap portion extends from and between each retaining portion to allow the pre-compression member to flex during assembly of the seal to accommodate the radius of the seal body.

### CROSS-REFERENCE TO RELATED APPLICATIONS

This application is a continuation-in-part (CIP) of co-pending application U.S. Ser. No. 12/813,118, filed Jun. 10, 2010, in the name of Jeffrey Eugene Swensen, Michael Sean Parker and Joseph Ilbong Kim for a “Pre-Compressed Seal Including Removable Pre-Compression Member”.

### BACKGROUND OF THE DISCLOSURE

The present invention relates to resilient seals for use in gas turbines or other devices requiring a sealing function between separate components, and particularly to a pre-compressed seal and method for retaining the pre-compressed seal in a pre-compressed state for installation into a gas turbine. In particular, the present invention relates to seals used in equipment typically divided into portions of a complete ring to facilitate assembly due to scale or complexity

In a gas turbine, hot gases flow through components of the various turbine and compressor stages. To minimize or prevent leakage flow between turbine engine components, seals have been developed and disclosed in U.S. Pat. Nos. 6,648,333 and 6,932,353, which describe seals having reversely folded marginal portions received in a cavity formed between two components. At operating conditions, the marginal portions seal against the base of the cavity and an adjacent turbine component to prevent leakage flow past the turbine components. To install the seal, the seal body is first compressed and maintained in a compressed state by applying one or more wraps about the seal body or a clip or an epoxy. At operating temperatures, the wrap, clip or epoxy burns off and releases the seal to engage the marginal portions against opposite sealing surfaces of the two components. Among other limitations, debris created as the wrap, clip or epoxy burns off may travel through the gas turbine and damage turbine components.

### BRIEF SUMMARY OF THE INVENTION

A seal is provided that includes a resilient, arc-shaped body having a pair of sealing portions movable between a pre-compressed state and a compressed state. A removable, arc-shaped pre-compression member slidingly engages the seal body along at least a portion of its length to hold the sealing portions in the pre-compressed state.

### BRIEF DESCRIPTION OF THE DRAWINGS

FIG. 1 is a plan view of a seal according to an embodiment of the present invention.

FIG. 2 is a cross-sectional view of the seal of FIG. 1.

FIG. 3 is a cross-sectional view of a seal according to another embodiment of the present invention.

FIG. 4 is a cross-sectional view of a gas turbine showing a seal according to an embodiment of the present invention positioned between two turbine components in a pre-compressed state,

FIG. 5 is a cross-sectional view of the gas turbine of FIG. 4 showing the seal in a compressed or installed state with the pre-compression released.

FIG. 6 is a cross-sectional view of a seal according to another embodiment of the present invention.

FIG. 7 is a cross-sectional view of a seal according to another embodiment of the present invention.

FIG. 8 is a cross-sectional view of a seal according to another embodiment of the present invention.

FIG. 9 is a cross-sectional view of a seal according to another embodiment of the present invention,

FIG. 10 is a cross-sectional view of a seal according to another embodiment of the present invention.

FIG. 11 is a top view of a pre-compression member according to another embodiment of the present invention.

FIG, 12 is a side view of the pre-compression member of FIG. 11.

FIG. 13 is a cross-sectional view of the pre-compression member of FIG. 11.

### DETAILED DESCRIPTION OF THE PREFERRED EMBODIMENT

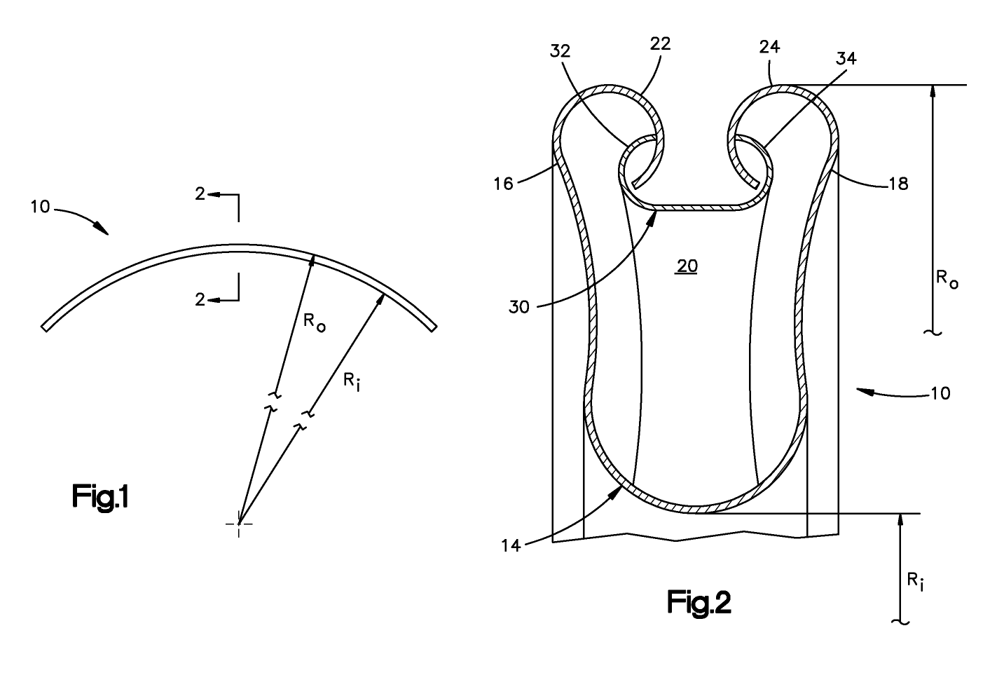

Referring now to the drawings, which are not intended to limit the invention, FIGS. 1 and 2 illustrate a segmented seal 10 according to an embodiment of the present invention. Seal 10 includes a resilient, arc-shaped body 14 having a generally U-shaped cross-section. Body 14 includes a pair of sealing portions 16, 18 defining a gap 20 in between. Each of the sealing portions 16, 18 includes a first retaining feature 22, 24, respectively, which extend into the gap 20. Body 14 is manufactured of a metal alloy, such as Inconel 718 or other suitable material used in gas turbines, using known manufacturing techniques. Body 14 may be manufactured in the desired segment length or longer lengths and then cut into segments (e.g., 4×90°, 6×60° etc.). Body 14 has a minimum radius Rᵢ and a maximum radius Rₒ,

Seal 10 also includes a removable, arc-shaped, pre-compression member 30 slidingly received in the gap 20. Pre-compression member 30 includes a pair of second retaining features 32, 34 that engage the first retaining features 22, 24, respectively, to hold the sealing portions 16, 18 in a pre-Compressed state shown in FIG, 2. The first and second retaining portions 22, 24, 32, 34 include interlocking ends that prevent the pre-compression member 30 from being removed from the body 14 except by sliding the pre-compression member 30 relative to and along the length of the body 14,

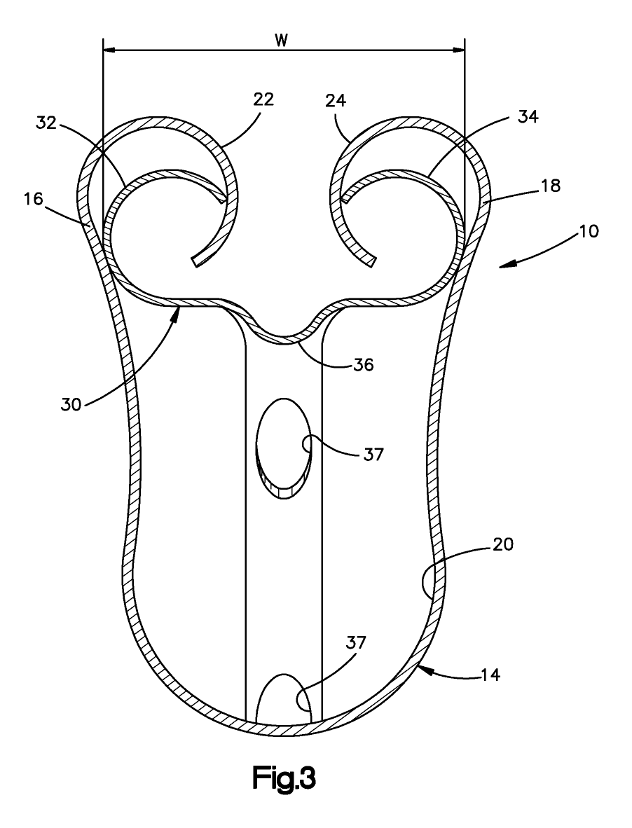

As shown in the embodiment of FIG. 3, pre-compression member 30 may be configured with an axial width W large enough to permit second retaining features 32, 34 to either contact (as shown in FIG, 3) or be closely positioned proximate first retaining features 22, 24 or sealing portions 16, 18 in the pre-compressed state. In this configuration, pre-compression member 30 is sized both to provide the desired amount of pre-compression and to prevent further compression of seal 10 that may cause disengagement of first and second retaining portions 22, 24, 32, 34 prior to installation.

In the illustrated embodiments, retaining portions 22, 24, 32, 34 exhibit a generally curved profile for ease of manufacture; however, non-curved profiles may also be used. In an exemplary implementation of the embodiment shown in FIG. 3, body 14 exhibits curved first retaining features 22, 24 each having a radius of about 0.07 in (1.78 mm). The described radius was found to be large enough to facilitate manufacturing, but not so large as to reduce the stiffness of first retaining features 22, 24 and prevent seal 10 from being retained in the pre-compressed state. The described radius also prevents the lever arm or effective length of the seal (i,e., the radial dimension extending from the bottom of the “U” in seal 10, outwards to the points at which seal 10 contacts the cavity (as explained below)) from being too short—a characteristic that reduces the spring-back or resiliency of seal 10. In the same implementation of the invention, pre-compression member 30 exhibits curved retaining features 32, 34 each having a radius of about 0.06 in (1.52 mm), allowing retaining features 32, 34 to fit inside of retaining features 22, 24 and provide enough rigidity to maintain pre-compression. A convolution 36 having a radius of about 0.035 in (0.89 mm) is located between retaining features 32, 34 to provide longitudinal stiffness that facilitates the pre-compression manufacturing process. Pre-compression member 30 may also include at least one and more preferably a plurality of holes 37 spaced apart a predetermined distance (e.g., approximately 1 ft (30.48 cm) apart) along its length. Holes 37 allow pre-compression member 30 to be gripped during removal from seal 10 in a manner that provides the most mechanical advantage and best angle to pull from throughout the removal process. The dimensions of pre-compression member 30 described above are exemplary and are not intended to limit the scope of the invention.

Pre-compression member 30 may be made from the same material as body 14 or other less expensive metal alloys or polymers since, unlike the prior art seals, the pre-compression member will not be subject to operating conditions of the turbine. During manufacture of seal 10, pre-compression member 30 is installed by compressing all or a portion of the seal segment to a height that allows pre-compression member 30 to be easily drawn through all or merely a portion of the seal body segment such that first and second retaining features 22, 24, 32, 34, are aligned and engaged to sufficiently retain seal 10 in the pre-compressed state. The manufacturing process may be accomplished manually, such as with a hand tool, or by using a fixture that maintains drawing force along the seal radius while compressing seal 10. Seal 10 and pre-compression member 30 may be lubricated using, for example, either a wet or dry high film strength lubricant, to ease the pre-compression process and subsequent release of seal 10 during installation,

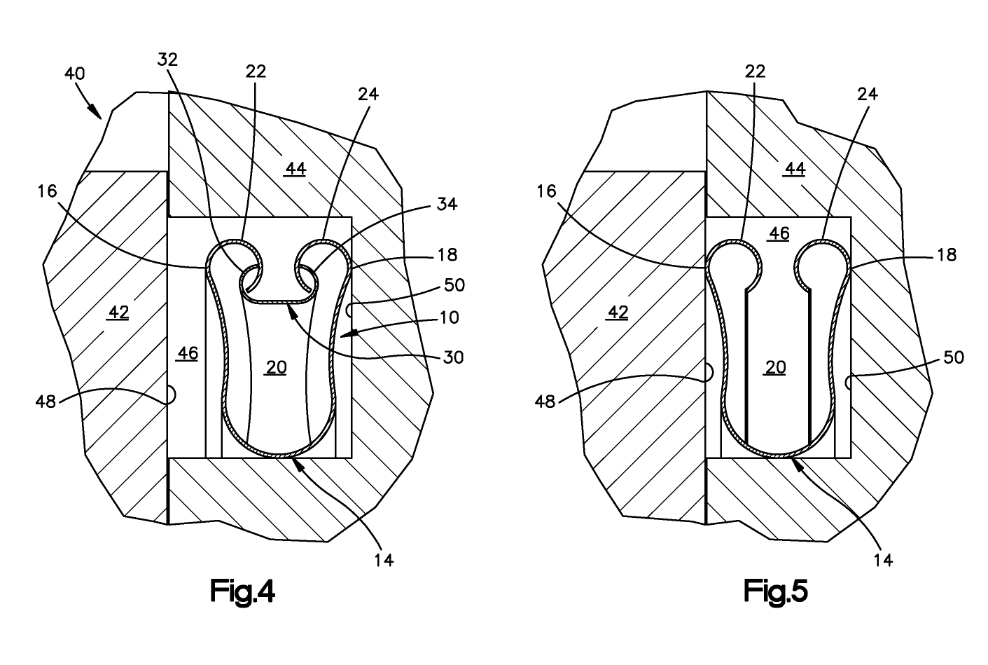

Referring to FIGS. 4 and 5, a segmented portion of a gas turbine 40 is shown that includes a first turbine component 42 and a second turbine component 44. First and second turbine components 42, 44 represent, for example, a turbine nozzle segment and a nozzle support ring or other turbine structure around which hot combustion gases may flow. A cavity 46 is defined between the first and second turbine components 42, 44 within which seal 10 is positioned. Cavity 46 defines, at least in part, a pair of adjacent sealing surfaces 48, 50. In FIG. 3, the sealing portions 16, 18 are located during assembly of the turbine between the adjacent sealing surfaces 48, 50 and held in a pre-compressed state by the pre-compression member 30 where only one (as shown) or none of the sealing portions 16, 18 are in contact with the adjacent sealing surfaces 48, 50.

In FIG. 5, the pre-compression member 30 is removed by sliding the arc-shaped pre-compression member 30 relative to and along the length of the arc-shaped body 14 releasing the resilient sealing portions 16, 18 for movement into a compressed state defined by sealing engagement with the adjacent sealing surfaces 48, 50. In practice, pre-compression member 30 is removed by pulling on pre-compression member 30 with a tool gripping the member 30 while simultaneously holding seal 10 in place with a second tool or fixture that inhibits frictionally induced forces from removing seal 10 from cavity 46. For larger seals 10, it may be necessary to utilize some form of mechanical advantage to affect removal of pre-compression member 30.

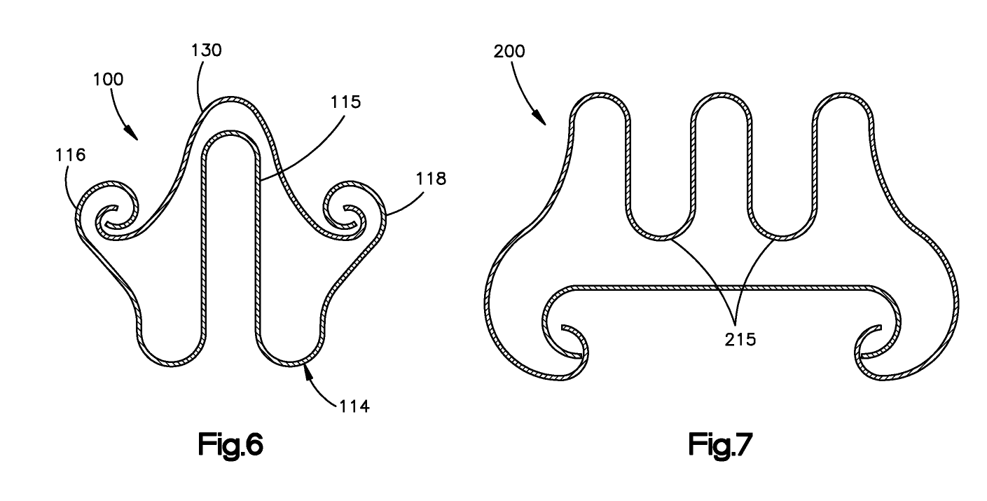

Referring to FIGS. 6 and 7, seals 100 and 200 according to different embodiments of the present invention are shown. In the embodiment shown in FIG. 6, seal 100 is substantially similar to seal 10, except that body 114 includes a convoluted portion 115 between the pair of sealing portions 116, 118. The pre-compression member 130 is shaped to accommodate the convolution 115. The embodiment shown in FIG. 7 includes a plurality of convolutions 215 of substantially even amplitude; however, the convolutions in both embodiments may have various shapes and sizes.

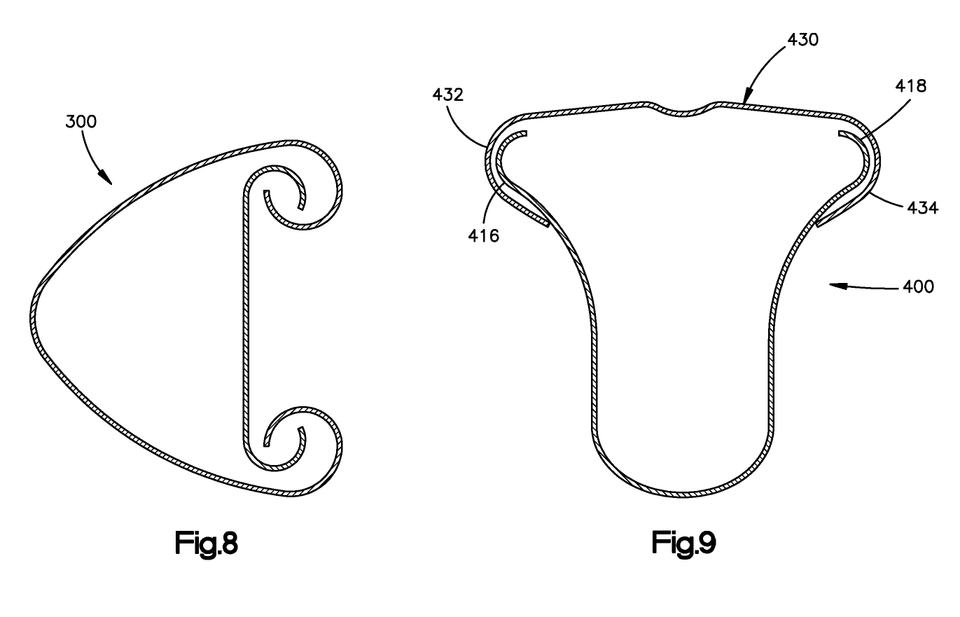

Referring to FIG. 8 a seal 300 is shown that is substantially similar to seal 10, except that body 114 exhibits a generally V-shaped cross-section. Various manipulations of the cross-sectional shape may be made to accommodate seal glands or cavities of different aspect ratios of height and width. Attendant variations in operating stress range associated with such cross-sectional forms are considered in the design optimization process.

Referring to FIG. 9, a seal 400 is shown that is substantially similar to seal 10 except that second retaining features 432, 434 of pre-compression member 430 are configured to extend over and engage an outer surface of sealing portions 416, 418. While several seal configurations have been illustrated to describe the invention, the invention is not limited to the illustrated embodiments.

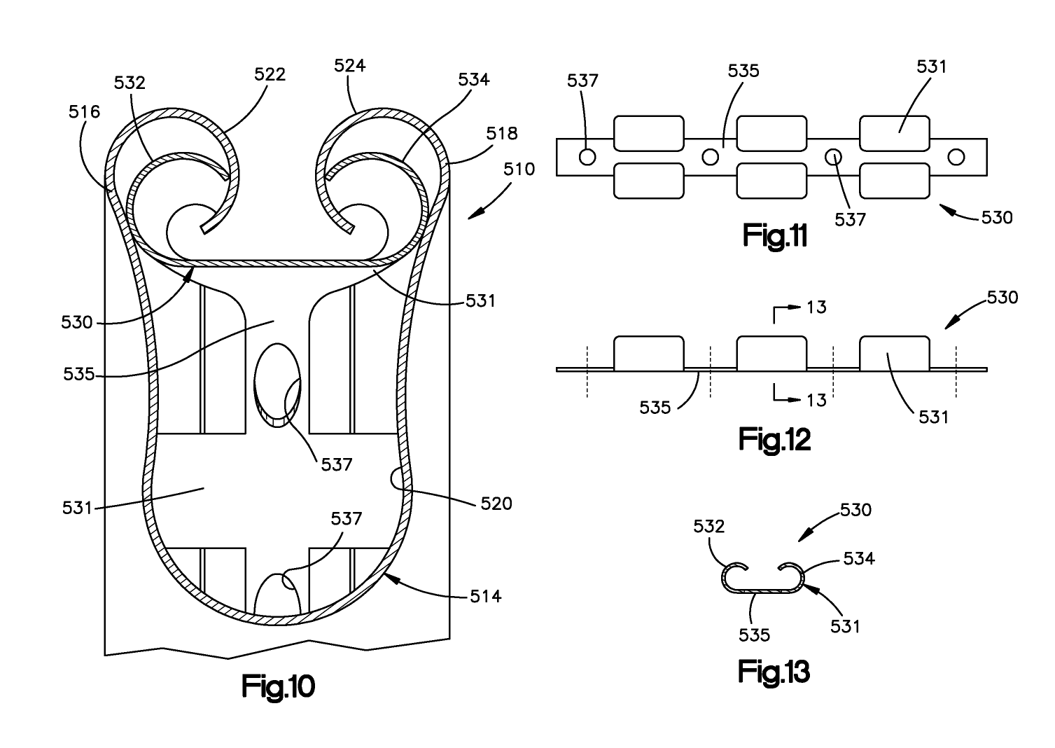

Referring to FIGS. 10-13, a seal 510 including a seal body 514 and a pre-compression member 530 according to another embodiment of the invention is shown. Pre-compression member 530 includes a retaining portion 531 having a pair of second retaining features 532, 534 that engage a pair of first retaining features 522, 524, respectively, of seal body 514 to hold sealing portions 516, 518 in a pre-compressed state shown in FIG. 10 in a manner substantially similar to the embodiments described above. Unlike the embodiments described above, pre-compression member 530 includes a strap portion 535 that extends from and between each retaining portion 531. In the illustrated embodiment, strap portions 535 are relatively flat compared to retaining portions 531 and have a thickness sized to permit pre-compression member 530 to flex and accommodate the radius of seal body 514. Strap portions 535 may include a hole 537 or similar feature to allow pre-compression member 30 to be gripped during removal from seal 510 as described above. It will be appreciated that the retaining portion 535 of pre-compression member 530 is not limited to the configuration shown in FIGS. 10-13 and that other retaining portion configurations, such as the configuration shown in FIGS. 6-9, may be used.

Among other benefits, pre-compression member 530 may be manufactured by progressive die forming rather than extensive progressive roll forming that may be used to achieve the generally arc-shaped body exhibited by pre-compression member 30, for example. Relatively high strength materials, such as carbon and stainless steel, are particularly suitable for use pre-compression member 530. Using this method of manufacture, pre-compression member 530 may exhibit a generally linear profile having a predetermined length that may be easily cut to size after forming as needed. During installation in seal 510, strap portions 535 allow pre-compression member 530 to flex and accommodate the radius of seal 510. This embodiment allows a single pre-compression member construction (e.g., dimensions, shape) to accommodate seals 510 of various radii.

Among other features, the inventive seal 10 prevents damage to a turbine caused by debris generated by prior art seals as the pre-compression wrap, clip, or epoxy material is burned off during operation of the engine. The invention also allows the pre-compression in seal 10 to be released during installation, but prior to engine operation, which allows the installer to ensure that seal 10 is properly installed and orientated in cavity 46. Prior art pre-compressed seals are neither seated nor engaged in cavity 46 until the engine is operated. This limitation leaves open the possibility that once the wrap, clip, or epoxy is burned off, the prior art seal may not be properly seated in the cavity and may lead to excessive leakage or break up and cause damage to the engine.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A seal comprising:
a resilient, arc-shaped seal body including a pair of sealing portions movable between a pre-compressed state and a compressed state; and
a removable pre-compression member slidingly engaging the seal body along at least a portion of its length to hold the sealing portions in the pre-compressed state.

2. The seal of claim 1, wherein the seal body includes a pair of first retaining features and the pre-compression member includes a retaining portion having a pair of second retaining features that engage the pair of first retaining features to hold the sealing portions in the pre-compressed state.

3. The seal of claim 2, wherein the pre-compression member includes at least one retaining portion including the first retaining features and a strap portion that extends from and between each retaining portion.

4. The seal of claim 3, wherein the strap portion is relatively flat compared to the retaining portion and has a thickness sized to permit pre-compression member to flex and accommodate a radius of the seal body.

5. The seal of claim 3, wherein the strap portions include a feature to allow the pre-compression member to be gripped during removal from the seal.

6. A method of installing a seal in a turbine having a pair of adjacent sealing surfaces, comprising the steps of:
providing a seal having a resilient arc-shaped body including a pair of resilient sealing portions movable between a pre-compressed state and a compressed state, and a removable pre-compression member engaging the seal body to hold the sealing portions in the pre-compressed state;
locating the seal between the adjacent sealing surfaces; and
sliding the pre-compression member relative to and along the length of the arc-shaped body releasing the resilient sealing portions for movement into engagement with the adjacent sealing surfaces in the compressed state.

7. The method of claim 6, wherein the providing step further includes providing a seal body including a pair of first retaining features and a pre-compression member including a retaining portion having a pair of second retaining features that engage the pair of first retaining features to hold the sealing portions in the pre-compressed state.

8. The seal of claim 7, wherein the providing step further includes providing a pre-compression member comprising at least one retaining portion including the first retaining features and a strap portion that extends from and between each retaining portion.

9. The seal of claim 8, further including the step of assembling the seal by flexing the pre-compression member during insertion into the seal body to accommodate a radius of the seal body.

10. The seal of claim 8, wherein the strap portions include a feature to allow the pre-compression member to be gripped during removal from the seal.
